(19) United States
(12) Patent Application Publication
(10) Pub. No.: US 2024/0168840 A1
(43) Pub. Date: May 23, 2024

(54) SELF-CALIBRATING A HEALTH STATE OF RESOURCES IN THE CLOUD

(71) Applicant: Microsoft Technology Licensing, LLC, Redmond, WA (US)

(72) Inventors: Huanghao XU, Nanjing (CN); Junjun SANG, Suzhou (CN); Joshua M. FOOKS, Sammamish, WA (US); Di GUO, Suzhou (CN); Scott GARGASH, Raleigh, NC (US); Fengjie DENG, Suzhou (CN); Jiayin HAN, Suzhou (CN)

(73) Assignee: Microsoft Technology Licensing, LLC, Redmond, WA (US)

(21) Appl. No.: 17/788,479

(22) PCT Filed: May 31, 2022
(86) PCT No.: PCT/CN2022/096503

§ 371 Date: Jun. 23, 2022

(51) Int. Cl. G06F 11/07; G06F 11/34

(52) U.S. Cl. CPC G06F 11/0793; G06F 11/0721; G06F 11/3495

(57) ABSTRACT

Systems and methods are provided for self-calibrating a health state of a hardware resource using a Siamese network based on a plurality of feature variables. The feature variables may include hardware failure data, performance degradation data, and power consumption data. The hardware failure data is based on machine operation records and warranty logs. The performance degradation data is based on hourly performance data and a number of client requests for performing functions. The power consumption data uses power telemetry and a processor (e.g., CPU) usage. The present disclosure uses a Siamese network with a plurality of trained neural networks in parallel to determine a correlation between incident data and reference data (e.g., representing a hardware resource in a healthy state). Use of the Siamese network enables self-calibrating a health status of servers in a cloud system without imposing stress tests or complex computations to classify the respective servers.

### BACKGROUND

Monitoring a health state of a hardware resource is critically important when the computer resource is a part of a system that operates 24 hours a day, seven days a week. Determining a health state associated with machines deployed in a cloud system becomes complex because of a large quantities and different types of servers and network equipment in the cloud system.

It is with respect to these and other general considerations that the aspects disclosed herein have been made. In addition, although relatively specific problems may be discussed, it should be understood that the examples should not be limited to solving the specific problems identified in the background or elsewhere in this disclosure.

### SUMMARY

Aspects of the present disclosure relate to a system for determining a health state of a hardware resource in a distributed network or cloud environment using a Siamese network. In particular, the disclosed technology includes self-calibrating a health state associated with a hardware installed in a cloud system. A method may include retrieving machine state data and generating a pair of embeddings based upon the state data. The pair of embeddings is a combination of two embeddings. The first embedding characterizes the current state of the hardware resource as incident data. The second embedding depicts normal conditions of the hardware resource as a reference to a healthy state. The Siamese network is trained using hardware resources in ground truth healthy states and sample pairs of an incident condition and a reference condition.

Once trained, the Siamese network predicts a health state (e.g., good health or poor health) of hardware based on a pair of embeddings where one of the pair of embeddings depict feature variables with values from the current condition and the other embeddings depict a reference (e.g., a healthy state). The Siamese network predicts a degree of similarity (e.g., correlation) between the embeddings. The degree of similarity determines either the hardware resource is in a healthy state or not in a healthy state.

Categories of feature variables include, but are not limited to, one or more of: failure operation data, performance data, and/or power telemetry data. The Siamese network receives a pair of embeddings as input and outputs a predicted health state. In an example, a pair of embeddings associated with failure operation data is based on a pair of failure incident data of a server, for example, and an annual failure rate of machines that are similar to the server. A pair of embeddings associated with performance data is based on a residual between performance data of the server and a prediction result for the server based on a regression model that depicts an average performance data of servers in the cluster. A pair of embeddings associated with power telemetry data is based on a pair of data representing an increase of a power consumption as the CPU utilization grows and data representing a power consumption when the machine is in an idle state.

The Siamese network includes a plurality of multi-layer convolutional neural networks in parallel, each receiving distinct one of the pair of embeddings as input and generating Siamese embeddings. The Siamese network predicts a health state based on a contrastive loss operation on the Siamese embeddings. At least one set of layers in a layer of the plurality of the multi-layer neural networks in parallel share an identical set of weights.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for self-calibrating a health state of resources in accordance with aspects of the present disclosure.

FIG. 2 illustrates an overview of an architecture in accordance with aspects of the present disclosure.

FIG. 3 illustrates example types of data for analyzing in accordance with aspects of the present disclosure.

FIG. 4 illustrates an example architecture of feature categories, Siamese network, and a health state in accordance with aspects of the present disclosure.

FIG. 5A illustrates an example of a method for training a Siamese network for determining a health state in accordance with aspects of the present disclosure.

FIG. 5B illustrates an example of a method for determining a health state in accordance with aspects of the present disclosure.

FIG. 6 is a block diagram illustrating example physical components of a computing device with which aspects of the disclosure may be practiced.

FIG. 7A is a simplified diagram of a mobile computing device with which aspects of the present disclosure may be practiced.

FIG. 7B is another simplified block diagram of a mobile computing device with which aspects of the present disclosure may be practiced.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

Determining a health state associated with hardware resources (e.g., servers, network routers, and other hardware) in a cloud system or a computing system helps identify hardware resources that are approaching end of lifecycle for replacement and/or identify hardware resources in need of repair. Determining the health state of hardware resources traditionally includes executing a stress test on the hardware resources and monitoring how various indicators of the hardware resources change or fail over time. Maintaining hardware resources in a cloud system becomes more complex and difficult to determine the health state because applying stress tests on the cloud may not be appropriate to accurately determine health states of select hardware resources.

Systems may use a trained machine learning system and predict health states of the hardware resources. A drawback, however, of using the trained machine learning system for monitoring hardware resources in cloud systems is the lack of sufficient training data to train machine learning models, particularly when there are a variety of different hardware resources operating in distinct geographical conditions and/or environments. For example, classification models may require extensive training data that are sufficient to accurately classify a health state of a hardware resource. For ease of description, aspects of the disclosure discussed herein relate to predicting a health state of a hardware resource. However, one of skill in the art will appreciate that the aspects disclosed herein may be used to predict the state of computing resources in general, including both physical, logical, and/or software components.

The present disclosure uses a Siamese network for determining whether incidental data associated with a hardware resource is in a healthy state (e.g., operating within a range of normal conditions) or in an unhealthy state (e.g., operating in a state that needs a repair or a replacement of the hardware resource). A Siamese network comprises two or more neural networks operating in parallel. An exemplary Siamese network in accordance with aspects of the present disclosure receives one or more embeddings with features corresponding to indicators of machine health, incident data, and/or reference data associated with the hardware resource. In response, the Siamese network predicts or determines a health state associated with the hardware resource. Use of the Siamese network enables determining a health state of a server and/or other resources in a cloud system (or distributed network, or local device(s)) based on a relatively simple processing of retrieving telemetry data about the server as compared to imposing stress tests on servers and other resources in the cloud system and executing complex statistical analyses.

As discussed in more detail below, the present disclosure is further directed to self-calibrating a health state of hardware resources in a cloud system. Examples of the hardware resources may include servers of various specifications, network routers and other devices, and the like. In particular, the disclosed technology uses a Siamese network to determine the health state of a hardware resource based on a comparison of feature values between recent data collected from the hardware resource and normal reference data that represents a state of hardware resources in average. In aspects, the health state may be a binary representation (e.g., healthy or unhealthy). The disclosed technology receives various parameters that indicate states that are relevant to a health of the hardware resources. Examples of types or feature variables associated with the various parameters may include hardware failure operation data, periodic performance data, and power telemetry data. Each parameter may include a pair of incidental data and reference data. The Siamese network receives a pair of embedding, one corresponding to embeddings associated with incidental data, and the other corresponding to embeddings associated with average or the normal conditions of the resources.

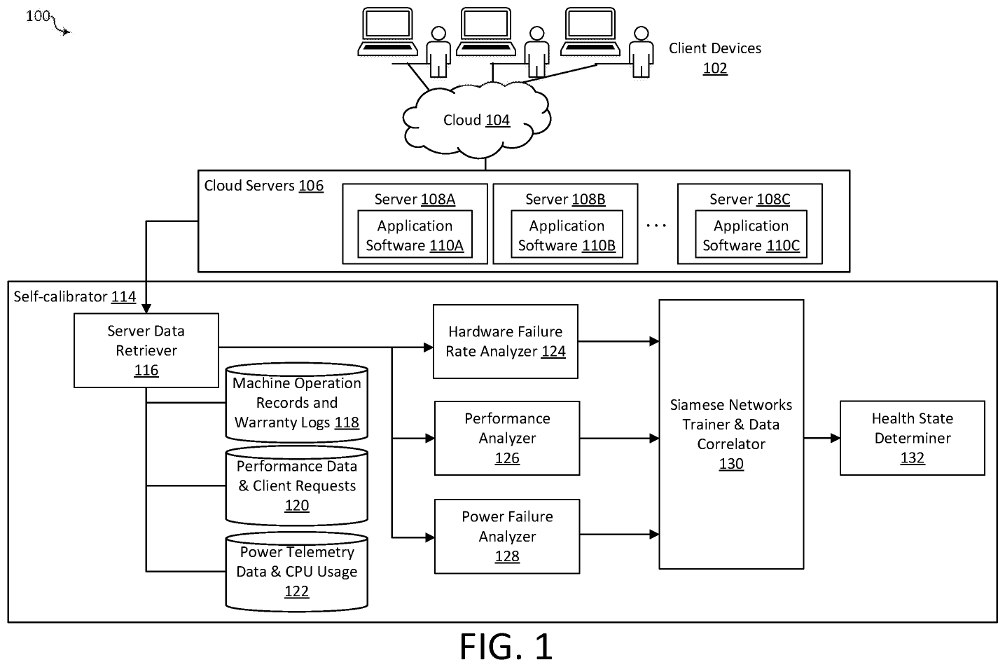

FIG. 1 illustrates an overview of an example system for self-calibrating a health state of resources in accordance with aspects of the present disclosure. The system 100 includes client devices 102 used by the end users. The client devices 102 connect to a cloud 104. The cloud 104 connects with cloud servers 106. The cloud servers 106 connects to a self-calibrator 114. The cloud servers 106 include one or more servers including server 108A, server 108B, and server 108C. The server 108A includes an application software 110A being executed in the server 108A. Similarly, the server 108B includes an application software 110B. The server 108C includes an application software 110C.

Self-calibrator 114 self-calibrates and determines a health state associated with a hardware resource (e.g., a server). In aspects, the self-calibrator 114 includes a server data retriever 116, a hardware failure rate analyzer 124, a performance analyzer 126, a power failure analyzer 128, a Siamese network trainer & data correlator 130, and a health state determiner 152. The server data retriever 116 may store in data stores data used for determining a health state of a server through analyzing the data. The data stores may include a machine operation records and warranty logs 118, periodic performance data and client requests 120, and a power telemetry data & CPU usage 122.

The hardware failure rate analyzer 124 analyzes failure operation data and generates a pair of embeddings that represent features associated with failure operations. In aspects, one of the pair of embeddings is based on features representing hardware failure incidents. The other one of the pair of embeddings is based on features representing a normal lifecycle of hardware operations. In an example, the hardware failure rate analyzer 124 retrieves machine operation records and warranty logs 118 as failure operation data.

In aspects, the hardware failure rate analyzer 124 finds a normal distribution for the failure observations by determining statistical values associated with hardware failure of the server and servers of the same or a similar type in average. The hardware failure rate analyzer 124 further uses the distribution to calculate the annual failure rate as the representation of the series of failure observations of the server.

The performance analyzer 126 analyzes software failure data and generates a pair of embeddings that represent feature variables associated with software failures and periodic performance data. In aspects, the performance analyzer 126 retrieves the periodic performance data & client requests 120.

In contrast to directly applying the time-series embedding techniques, the performance analyzer 126 may use the residual of linear regression model to compress data that indicate performance reduction from time-series observations. The performance analyzer 126 generates a pair of embeddings. One of the pair of embeddings indicates performance reduction of the server being executed on the server. The other embeddings indicate a linear regression model predicting how performance of the server degrades over time in average. In aspects, the performance analyzer 126 may prevent a biased influence upon the linear regression model by feature variables that are independent among servers. An example of the feature variables may include a machine age. The performance analyzer 126 may prevent the biased influence by not including feature variables that are independent from one server to another server (e.g., a machine age) in aggregating features for generating the linear regression model.

The power failure analyzer 128 analyzes power telemetry data and generates embeddings that represent feature variables associated with power consumption of a server. The power failure analyzer 128 uses the power telemetry data & CPU usage 122 as the basis of a data analysis. In aspects, the power failure analyzer 128 uses a self-linear regression model of a server to compress a series of power consumption data into two parts. A first part indicates power consumption of the server when CPU utilization rate increases as the server is in a busy state. A second part indicates power consumption of the server when the server is in an idle state. The server in the busy state executes an instruction code of a software in response to receiving client requests (e.g., a busy state). In aspects, power consumption data in the first part represent incident data while power consumption data in the second part represent reference data.

The model may represent the average cost for servicing client requests in a set of hardware resources (e.g., a server fleet). The residual between the actual machine performance data and the predicted performance data of the model indicates of how much the actual machine performance deviates from machine performance as expected in average. In contrast to using statistical data among servers, use of the self-linear regression model based on the server's own power consumption statistics may accurately predict a health state of the server.

The Siamese network trainer & data correlator 130 trains a Siamese network using the pair of embeddings that have been generated by one or more analyzers (e.g., the hardware failure rate analyzer 124, the performance analyzer 126, and the power failure analyzer 128). Once trained, the Siamese network trainer & data correlator 130 uses the Siamese network and determines correlation between embeddings of the pair of embeddings.

In an example, one of the pair of embeddings represents incident data associated with a server or a hardware resource in the cloud system. The other of the pair of embeddings represents reference data based on an average data associated with the server and/or among servers of the same or similar types. The Siamese network may include a pair of neural networks, respectively processing one or the other embeddings of the pair of embeddings.

The health state determiner 132 determines a health state of the server. In aspects, the health state indicates at least a healthy state or an unhealthy state. The health state may be binary. The health state may be used as among information needed to determine whether to decommission and replace the server.

As will be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

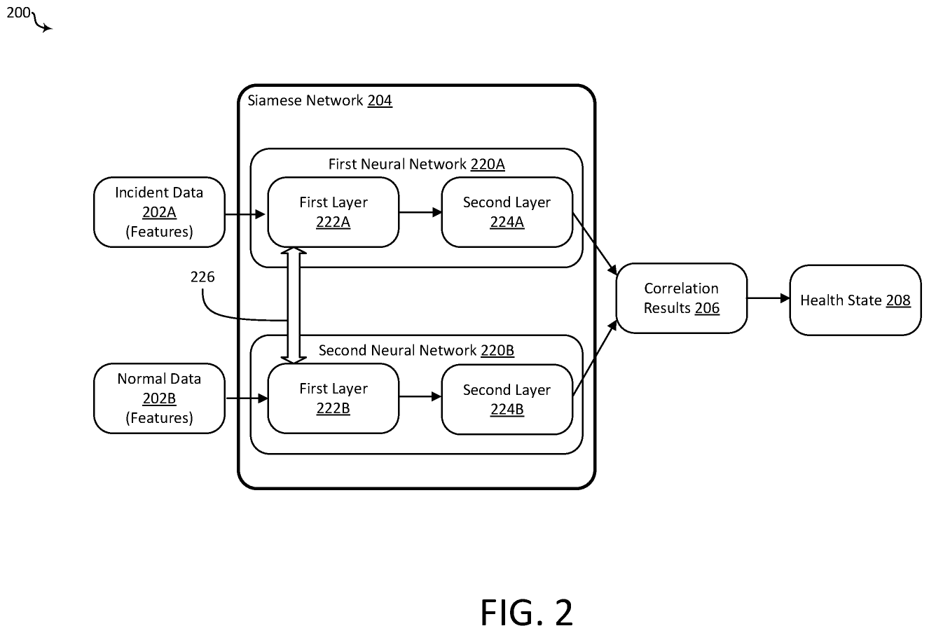

FIG. 2 illustrates an overview of architecture in accordance with aspects of the present disclosure. The data structure 200 includes incident data 202A (features), normal data 202B (features), a Siamese network 204, correlation results 206, and a health state 208. The Siamese network 202 further includes at least a pair of neural networks: a first neural network 220A and a second neural network 220B. The first neural network 220A includes at least a first layer 222A and a second layer 224A. the second neural network 220B includes at least a first layer 222B and a second layer 224B. In an example, the first layer 222A and the first layer 222B share common weight values 226.

The incident data 202A (features) represent an input vector that represents embeddings based on incident values of feature variables of a server. In aspects, the incident data 202A aggregates results from analyzing statistical data associated with the server in one or more feature categories (e.g., machine hardware failure, machine performance data, and/or power consumption data, etc.).

The normal data 202B (features) represent reference data to correlate to the incident data 202A. In an example, the normal data 202B represent a reference vector that embeds reference (e.g., normal/good values in average) data of the same feature variables as used in the incident data 202A. In aspects, the incident data 202A and the normal data 202B may be normalized to prevent bias among feature variables across the categories.

The Siamese network 204 includes a plurality of neural networks in parallel. In an example, the Siamese network 204 includes two neural networks: a first neural network 220A and a second neural network 220B. The first neural network 220A and the second neural network 220B respectively include two layers. The first layer 222A of the first neural network 220A and the first layer 222B of the second neural network 220B share common weight values 226 for attaining a level of consistency in predicting correlations of data between the first neural network 220A and the second neural network 220B.

The correlation results 206 indicate a degree of correlation between the incident data and the normal data as determined using the Siamese network 204. In aspects, the degree of correlation may be expressed as a percentage.

The health state 208 indicates whether a resource (e.g., a server) is healthy or unhealthy. In aspects, a hardware resource is healthy when the correlation results 206 are higher than a predetermined threshold, indicating a high correlation between the incident data and the normal data as a reference. In contrast, the resource is unhealthy when the correlation is relatively low, indicating that incident data of the resource deviates from the normal data.

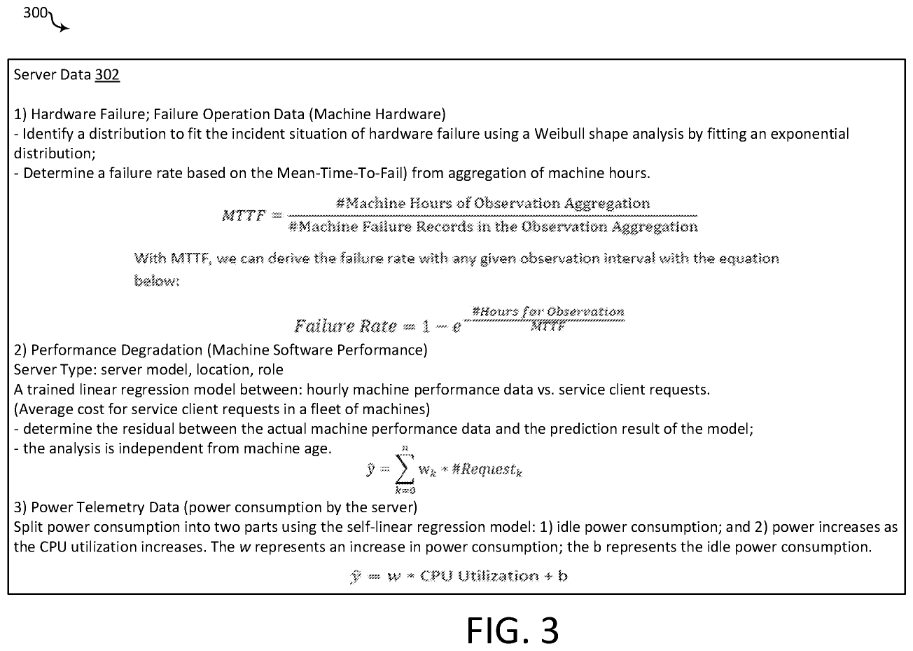

FIG. 3 illustrates example categories or types of feature variables for self-calibrating a health state in accordance with aspects of the present disclosure. In an example, the categories of feature variables may include hardware failure, performance degradation (e.g., machine software performance), and power consumption (e.g., power telemetry data for the server).

A hardware failure rate analyzer (e.g., the hardware failure rate analyser 124 as shown in FIG. 1) finds a normal distribution for the failure observations by determining statistical values associated with hardware failure of the server and/or servers of the same or a similar type in average. In aspects, the normal distribution may be based on a Weibull shape analysis by fitting an exponential function. The hardware failure rate analyzer calculates the annual failure rate based on a Mean Time To Fail (MTTF).

$$MTTF = \frac{\#Machine Hours of Observation Aggregation}{\begin{matrix}\#Machine Failure Records \\ in the Observation Aggregation\end{matrix}} \qquad ( 1 )$$

$$Failure Rate = 1 - {e}^{- \frac{\# Hours for Observation}{M T T F}} \qquad ( 2 )$$

In determining performance degradation, a performance analyzer (e.g., the performance analyzer 126 as shown in FIG. 1) analyzes generates a pair of embeddings that represent features associated with performance of a server. Performance data may depend on various types of servers as indicated by server models, locations of the servers, and roles (e.g., database servers, graphics processing servers, and the like) assigned to the respective servers in the cloud system.

In contrast to directly applying the popular time-series embedding techniques, the performance analyzer 126 uses the residual of linear regression model to compress the performance drop information from time-series observations.

ŷ=Σₖ₌₀ⁿwₖ*#Requestₖ (3)

The model represents the average cost for service client requests in a cluster of machines. The residual between the actual machine performance data and the predicted result of the model is a good measurement of how much the machine performance deviates from the cluster average.

In determining degradation associated with power failures, a power failure analyzer (e.g., the power failure analyzer 128 as shown in FIG. 1) uses the self-linear regression model to split power consumption into two parts: 1.) idle power consumption; 2.) power grows as the CPU utilization grows. In aspects, the power failure analyzer 128 uses a self-linear regression model to compress a series of power consumption data into two parts: an increase of CPU utilizations as the server receives client requests and a CPU utilization when the server is in an idle state.

The linear regression model can be described as below:

ŷ=w*CPU Utilization+b (4)

The w in the linear regression model can represent the increase in power consumption as CPU usage increases, while b represents the idle power consumption. Production systems use one week-long time series to calculate the self-regression model parameters for each machine.

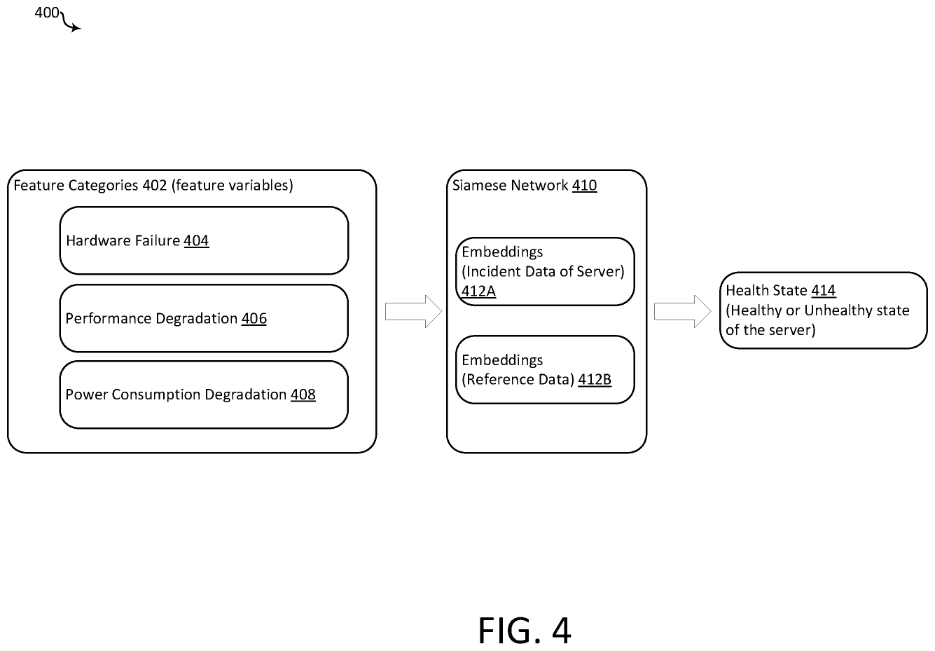

FIG. 4 illustrates an example architecture in accordance with aspects of the present disclosure. Architecture 400 includes feature categories 402 (feature variables), a Siamese network 410, and a health state 414. The feature categories 402 include one or more feature categories associated with a server (e.g., a hardware resource in the cloud), which characterizes the server in determining an end-of-life replacement of the server. For example, the feature categories 402 include at least in part and not limited to hardware failure 404, performance degradation 406, and power consumption degradation 408. The hardware failure 404 category indicates a likelihood of the server hardware to fail. An example of the hardware failure 404 may include a failure rate based on a mean time until the hardware to fail.

Performance degradation 406 indicates how performance of a server degrades over time as specifications of the server become outdated or some parts of the server including a performance of software execution deteriorates over time. Power consumption degradation 408 indicates how an efficiency of power consumption by the server degrades over time.

The Siamese network 410 includes embeddings (incident data of the server) 412A and embeddings (reference data) 412B. Embeddings represent a multi-dimensional vector with respective dimensions corresponding to feature variables being used to determine a correlation between incident data (e.g., the current state of the server) and reference data (e.g., the representative healthy server as a reference).

The health state 414 indicates a health state of the server. The health state may be binary: healthy or unhealthy. For example, the healthy health state indicates that the server is healthy and may continue to be deployed. In contrast, the unhealthy health state indicates that the server is unhealthy and needs an attention for maintenance work or replacement.

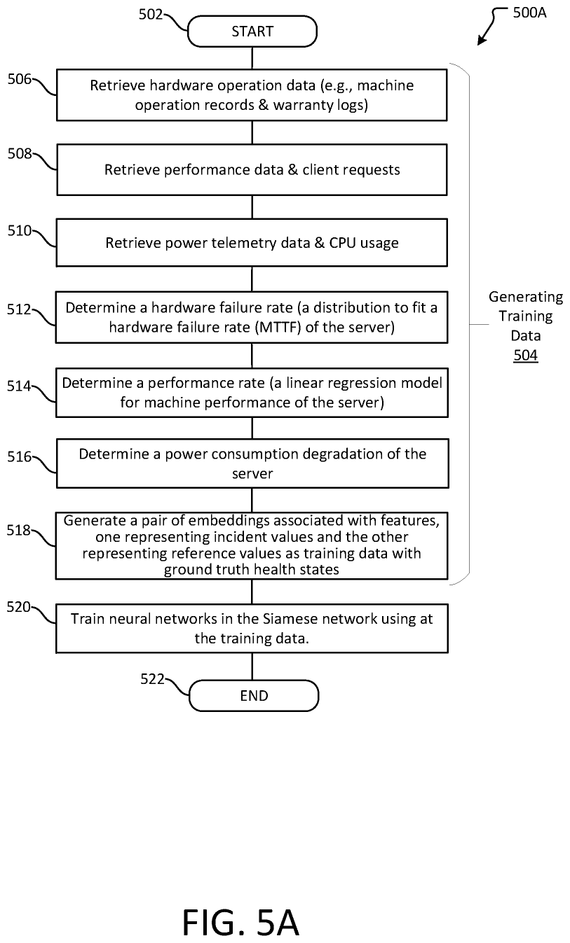

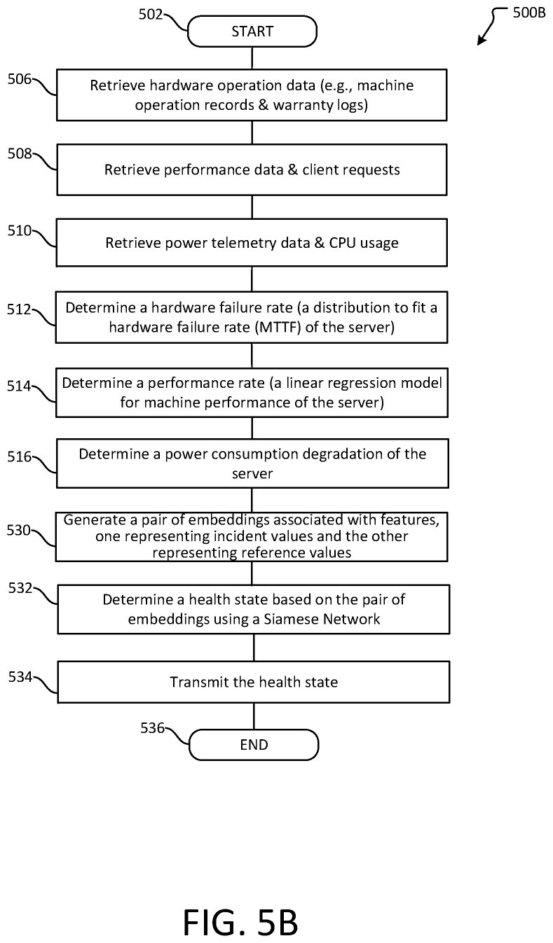

FIG. 5A illustrates an example of a method for training a Siamese network in accordance with aspects of the present disclosure. A general order of the operations for the method 500A is shown in FIG. 5A. Generally, the method 500A begins with start operation 502 and ends with end operation 522. The method 500A may include more or fewer steps or may arrange the order of the steps differently than those shown in FIG. 5A. The method 500A can be executed as a set of computer-executable instructions executed by a computer system and encoded or stored on a computer readable medium. Further, the method 500A can be performed by gates or circuits associated with a processor, an ASIC, an FPGA, a SOC or other hardware device. Hereinafter, the method 500A shall be explained with reference to the systems, components, devices, modules, software, data structures, data characteristic representations, signaling diagrams, methods, etc., described in conjunction with FIGS. 1, 2, 3, 4, 5B, 6, and 7A-B.

Following start operation 502, the method 500A begins with a series of operations to generate (504) training data for training the Siamese network. The training data may include one or more categories of features associated with determining a health state of a computing resource. Examples of the one or more categories include hardware failure during machine operations, performance data, and power consumption data. The series of operations begins with retrieving hardware operation records operation 506, which retrieves machine operation records and warranty logs. In aspects, the machine operation records indicate a history of hardware failures associated with servers and other resources in the cloud systems. The retrieved machine operation records and warranty logs 118 may be stored in the machine operation records and warranty logs 118 as shown in FIG. 1.

Retrieve performance data and client requests operation 508 retrieves data that indicate a performance of a server. Examples of data that indicate a performance of the server may include an hourly log of performance data associated with the server. The performance may be expressed based on records of executing software program instructions on the server. The retrieved performance data and client requests may be stored in the performance data & client requests 120 database as shown in FIG. 1.

Retrieve power telemetry data operation 510 retrieves power consumption data and CPU usage data. In aspects, the retrieve power telemetry data operation 510 retrieves power consumption data associated with a server at the latest time as incident data. The retrieve power telemetry data operation 510 further retrieves data associated with power consumption by servers of a similar type at the time or by the server over time. The power consumption data by the servers of the similar type at the time or by the server over time may be used as the basis for determining reference data for the server in a healthy state. The power telemetry data and CPU usage data may be stored in the power telemetry data & CPU usage 122 database as shown in FIG. 1.

Determine hardware failure rate operation 512 determines a distribution to fit hardware failure rates. In aspects, the determine hardware failure rate operation 512 (e.g., the hardware failure rate analyzer 124 as shown in FIG. 1) uses a Weibull shape analysis and determines the distribution to fit failure with a failure rate.

Determine performance rate operation 514 determines performance rates degradation based on a difference between the instant performance data of the server and performance of the server when the server is in an idle state. For example, the performance analyzer 126 may perform the determine performance rate operation 514.

Determine power consumption degradation operation 516 determines a linear regression model associated with a power consumption level of the server. The determine power consumption degradation operation 516 further determines a degradation of power consumption rate based on a difference between the linear regression model and the current power consumption by the server. In aspects, the power failure analyzer 128 may perform the determine power consumption operation 516.

Generate operation 518 generates a pair of embeddings representing values for feature attributes at incident values and reference values. In aspects, embeddings include a multi-dimensional vector, including dimension representing respectively feature variables in categories including hardware failures, performance degradation, and power consumption degradation. In further aspects, the generate operation 518 generates ground a truth health state for each of embeddings for training. In an example, some of embeddings based on incident values may be labeled their health state as unhealthy.

Train operation 520 trains neural networks in a Siamese network using one or more of the embeddings as training data. In an example, the Siamese network includes two neural networks. In aspects, both of the neural networks may be trained using the same training data. The respective neural networks include at least two layers. A pair of the first layer may share a common set of weight values. The method 500A ends with the end operation 522.

As should be appreciated, operations 502-522 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 5B illustrates an example of a method for determining a health state in accordance with aspects of the present disclosure. A general order of the operations for the method 500B is shown in FIG. 5B. The method 500B uses a trained Siamese network to determine a health state of a computing resource. Generally, the method 500B begins with start operation 502 and ends with end operation 536. The steps from a retrieving hardware operation records operation 506 through a determine a power consumption degradation operation 516 may be the same as the steps as shown in FIG. 5A. The method 500B may include more or fewer steps or may arrange the order of the steps differently than those shown in FIG. 5B. The method 500B can be executed as a set of computer-executable instructions executed by a computer system and encoded or stored on a computer readable medium. Further, the method 500B can be performed by gates or circuits associated with a processor, an ASIC, an FPGA, a SOC or other hardware device. Hereinafter, the method 500B shall be explained with reference to the systems, components, devices, modules, software, data structures, data characteristic representations, signaling diagrams, methods, etc., described in conjunction with FIGS. 1, 2, 3, 4, 5A, 6, and 7A-B.

Following start operation 502, the method 500B begins with retrieving hardware operation records operation 506, which retrieves machine operation records and warranty logs. In aspects, the machine operation records indicate a history of hardware failures associated with servers and other resources in the cloud systems. Retrieve performance data and client requests operation 508 retrieves data that indicate a performance of a server.

Retrieve power telemetry data operation 510 retrieves power telemetry data and CPU usage data. In aspects, the retrieve power telemetry data operation 510 retrieves power consumption data associated with a server at the latest time as incident data. The retrieve power telemetry data operation 510 further retrieves data associated with power consumption by servers of a similar type at the time or by the server over time. The power consumption data by the servers of the similar type at the time or by the server over time may be used as the basis for determining reference data for the server in a healthy state.

Determine hardware failure rate operation 512 determines a distribution to fit hardware failure rates. In aspects, the determine hardware failure rate operation 512 uses a Weibull shape analysis and determines the distribution to fit failure with a failure rate.

Determine performance rate operation 514 determines performance rates degradation based on a difference between the instant performance data of the server and performance of the server when the server is in an idle state.

Determine power consumption operation 516 determines a linear regression model associated with a power consumption level of the server. The determine power consumption operation 516 further determines a degradation of power consumption rate based on a difference between the linear regression model and the current power consumption by the server.

Generate operation 530 generates a pair of embeddings representing values for feature attributes at incident values and reference values. In aspects, embeddings include a multi-dimensional vector, including dimension representing respectively feature variables in categories including hardware failures, performance degradation, and power consumption degradation.

Determine a health state operation 532 determines a health state based on incident data using the trained Siamese network. In aspects, the health state may be either healthy or unhealthy. The health state may be determined based on a degree of correlation between the pair of embeddings. For example, the server may be in an unhealthy state when a degree of correlation between the pair of embeddings (the incident data and the reference data) is less than a predetermined threshold.

Transmit operation 534 transmits the determined health state of the server. In aspects, the determined health state may be used as among the basis for determining whether to replace the server. The method 500B ends with the end operation 536.

As should be appreciated, operations 502-536 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

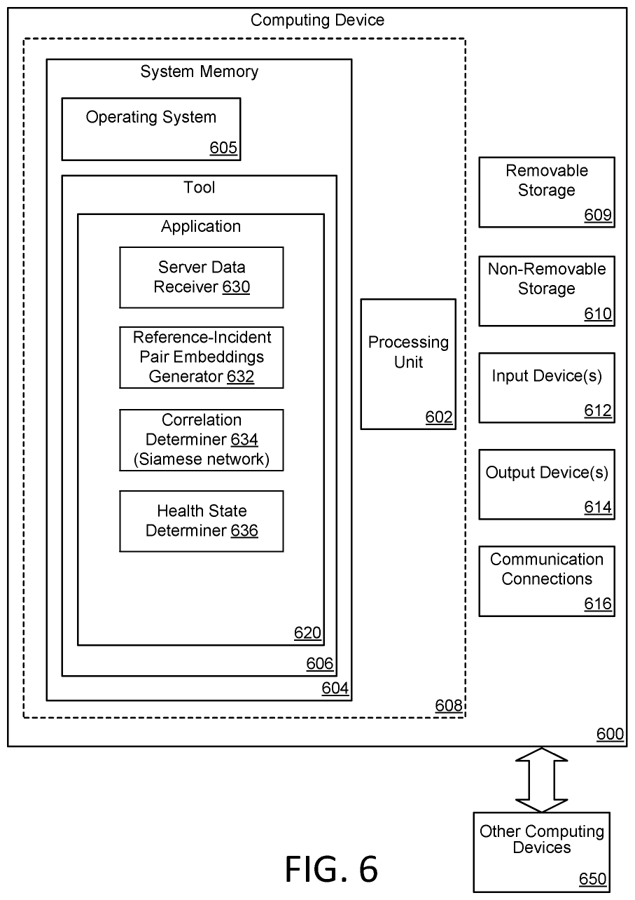

FIG. 6 is a block diagram illustrating physical components (e.g., hardware) of a computing device 600 with which aspects of the disclosure may be practiced. The computing device components described below may be suitable for the computing devices described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program tools 606 suitable for performing the various aspects disclosed herein such. The operating system 605, for example, may be suitable for controlling the operation of the computing device 600. Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program tools and data files may be stored in the system memory 604. While executing on the at least one processing unit 602, the program tools 606 (e.g., an application 620) may perform processes including, but not limited to, the aspects, as described herein. The application 620 includes a server data retriever 630, a reference-incident pair embeddings generator 632, a correlation determiner 634 (A Siamese network), and a health state determiner 636 as described in more details in FIG. 1. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units, and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 600 may also have one or more input device(s) 612, such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of the communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

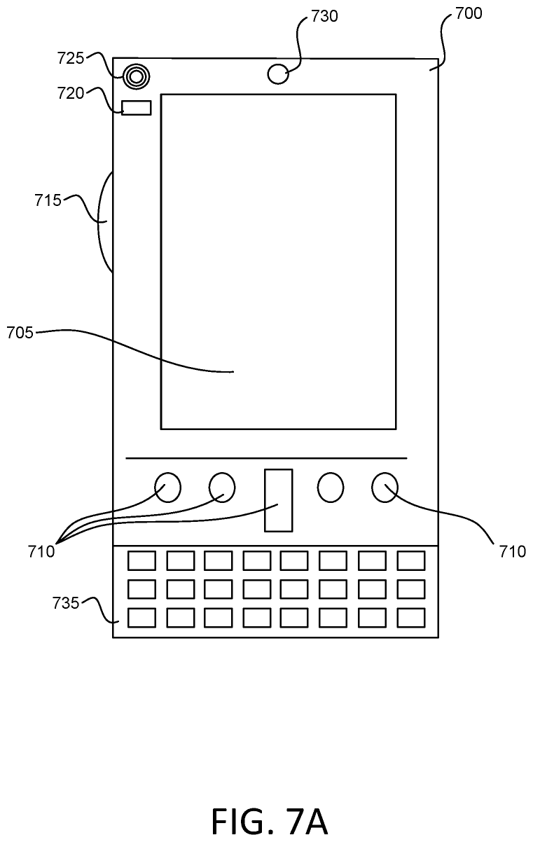

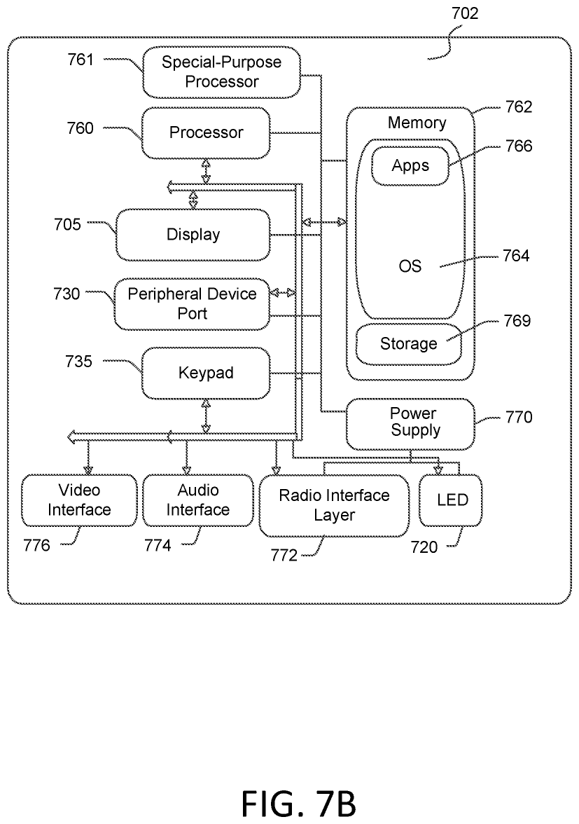

FIGS. 7A and 7B illustrate a computing device or mobile computing device 700, for example, a mobile telephone, a smart phone, wearable computer (such as a smart watch), a tablet computer, a laptop computer, and the like, with which aspects of the disclosure may be practiced. In some aspects, the client utilized by a user (e.g., the client devices 102 as shown in the system 100 in FIG. 1) may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included as an optional input element, a side input element 715 allows further user input. The side input element 715 may be a rotary switch, a button, or any other type of manual input element. In alternative aspects, mobile computing device 700 may incorporate more or less input elements. For example, the display 705 may not be a touch screen in some aspects. In yet another alternative aspect, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of computing device, a server (e.g., servers 108A-C and a self-calibrator 114 as shown in FIG. 1), a mobile computing device, etc. That is, the mobile computing device 700 can incorporate a system 702 (e.g., a system architecture) to implement some aspects. The system 702 can implemented as a “smart phone” capable of running one or more applications (e.g., browser, e-mail, calendaring, contact managers, messaging clients, games, and media clients/players). In some aspects, the system 702 is integrated as a computing device, such as an integrated digital assistant (PDA) and wireless phone.

One or more application programs 766 may be loaded into the memory 762 and run on or in association with the operating system 764. Examples of the application programs include phone dialer programs, e-mail programs, information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 868 synchronized with corresponding information stored at the host computer. As should be appreciated, other applications may be loaded into the memory 762 and run on the mobile computing device 700 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 (e.g., LED) may be used to provide visual notifications, and/or an audio interface 774 may be used for producing audible notifications via the audio transducer 725. In the illustrated configuration, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of devices connected to a peripheral device port 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure relates to systems and methods for self-calibrating machine health according to at least the examples provided in the sections below. The computer-implemented method comprises retrieving one or more feature variables and feature data associated with a hardware resource, wherein the one or more feature variables include machine failure data; determining failure data corresponding to the one or more feature variables; generating a pair of embeddings associated with the one or more feature variables of the hardware resource; determining, based on the pair of embeddings using a Siamese network, a health state of the hardware resource; and causing, based on the health state, determination of whether to replace the hardware resource. The one or more feature variables corresponds to at least one of: a hardware failure occurrence, a performance degradation, or a power consumption degradation. The Siamese network includes a plurality of neural networks in parallel, wherein one of the plurality of neural networks receives first embeddings representing reference data as input, and wherein another one of the plurality of neural networks receives second embeddings representing incident data as input. The method further comprises retrieving hardware operation data, wherein the hardware operation data include machine operation records and warranty log data associated with the hardware resource; retrieving performance data associated with the hardware resource and data associated with client requests received by the hardware resource; and retrieving power telemetry data and processor utilization data. The method further comprises determining a hardware failure rate associated with the hardware resource, wherein the hardware resource includes a server; determining a performance rate associated with the hardware resource; and determining a power consumption data associated with the server. The Siamese network includes a first neural network and a second neural network, and wherein a first layer of the first neural network and a first layer of the second neural network are trained by sharing common weight values. The determining the hardware failure rate is based on fitting an exponential distribution of hardware failures associated with a set of hardware resources with hardware failures associated with the hardware resource. The determining a performance rate includes determining a residual of a linear regression model between hourly machine performance data and a number of client requests received on the server. The determining a power consumption degradation further includes determining a residual of a linear regression model indicating an increase of power consumption as a processor utilization increases and a power consumption by the hardware resource when the hardware resource is in an idle state.

Another aspect of the technology relates to a system for self-calibrating machine health. The system comprises a processor; and a memory storing computer-executable instructions that when executed by the processor cause the system to execute a method comprising: retrieving hardware operation data associated with a server; retrieving performance data associated with the server; retrieving power telemetry data associated with the server; determining a hardware failure rate associated with the server; determining a performance rate associated with the server; determining a power consumption rate associated with the server; generate, based on a combination of the hardware failure rate, the performance rate, and the power consumption rate, a pair of embeddings associated with the server; determining, based on the pair of embeddings using a Siamese network, a health state of the server; and causing, based on the health state, determination of whether to replace the server. The computer-executable instructions that when further executed by the processor cause the system to execute a method comprises training, based at least in part on the pair of embeddings, the Siamese network. The Siamese network includes a plurality of neural networks in parallel, wherein one of the plurality of neural networks receives first embeddings representing reference data as input, and wherein another one of the plurality of neural networks receives second embeddings representing incident data as input. The Siamese network includes a first neural network and a second neural network, and wherein a first layer of the first neural network and a first layer of the second neural network are trained by sharing common weight values. The determining the hardware failure rate is based on fitting an exponential distribution of hardware failures associated with a set of hardware resources with hardware failures associated with the server. The determining a performance rate includes determining a residual of a linear regression model between hourly machine performance data and a number of client requests received on the server. The determining a power consumption degradation further includes determining a residual of a linear regression model indicating an increase of power consumption as a processor utilization increases and a power consumption by the server when the server is in an idle state.

In still further aspects, the technology relates to a computer-implemented method. The method comprises retrieving data associated with feature variables, wherein the feature variables indicate a health state of a hardware resource, wherein the feature variables include performance data associated with the hardware resource; determining degradation of values associated with the feature variables using a linear regression model; training a Siamese network using embeddings representing a healthy state as training data; and determining, based on a plurality of embeddings associated with the feature variables, the health state using the trained Siamese network. The Siamese network includes a plurality of neural networks in parallel, wherein one of the plurality of neural networks receives first embeddings representing reference data as input, and wherein another one of the plurality of neural networks receives second embeddings representing incident data as input. The Siamese network includes a first neural network and a second neural network, and wherein a first layer of the first neural network and a first layer of the second neural network are trained by sharing common weight values. The determining degradation of values associated with the feature variables includes determining a residual of a linear regression model between hourly machine performance data and a number of client requests received on the hardware resource.

Any of the one or more above aspects in combination with any other of the one or more aspect. Any of the one or more aspects as described herein.

What is claimed is:

1. A computer-implemented method, the method comprising:
retrieving one or more feature variables and feature data associated with a hardware resource, wherein the one or more feature variables include machine failure data;
determining failure data corresponding to the one or more feature variables;
generating a pair of embeddings associated with the one or more feature variables of the hardware resource;
determining, based on the pair of embeddings using a Siamese network, a health state of the hardware resource; and
causing, based on the health state, determination of whether to replace the hardware resource.

2. The computer-implemented method of claim 1, wherein the one or more feature variables corresponds to at least one of:
a hardware failure occurrence,
a performance degradation, or
a power consumption degradation.

3. The computer-implemented method of claim 1, wherein the Siamese network includes a plurality of neural networks in parallel, wherein one of the plurality of neural networks receives first embeddings representing reference data as input, and wherein another one of the plurality of neural networks receives second embeddings representing incident data as input.

4. The computer-implemented method of claim 1, the method further comprising:
retrieving hardware operation data, wherein the hardware operation data include machine operation records and warranty log data associated with the hardware resource;
retrieving performance data associated with the hardware resource and data associated with client requests received by the hardware resource; and
retrieving power telemetry data and processor utilization data.

5. The computer-implemented method of claim 1, the method further comprising:
determining a hardware failure rate associated with the hardware resource, wherein the hardware resource includes a server;
determining a performance rate associated with the hardware resource; and
determining a power consumption data associated with the server.

6. The computer-implemented method of claim 1, wherein the Siamese network includes a first neural network and a second neural network, and wherein a first layer of the first neural network and a first layer of the second neural network are trained by sharing common weight values.

7. The computer-implemented method of claim 5, wherein the determining the hardware failure rate is based on fitting an exponential distribution of hardware failures associated with a set of hardware resources with hardware failures associated with the hardware resource.

8. The computer-implemented method of claim 5, wherein the determining a performance rate includes determining a residual of a linear regression model between hourly machine performance data and a number of client requests received on the server.

9. The computer-implemented method of claim 5, wherein the determining a power consumption degradation further includes determining a residual of a linear regression model indicating an increase of power consumption as a processor utilization increases and a power consumption by the hardware resource when the hardware resource is in an idle state.

10. A system comprising:
a processor; and
a memory storing computer-executable instructions that when executed by the processor cause the system to execute a method comprising:
retrieving hardware operation data associated with a server;
retrieving performance data associated with the server;
retrieving power telemetry data associated with the server;
determining a hardware failure rate associated with the server;
determining a performance rate associated with the server;
determining a power consumption rate associated with the server;
generate, based on a combination of the hardware failure rate, the performance rate, and the power consumption rate, a pair of embeddings associated with the server;
determining, based on the pair of embeddings using a Siamese network, a health state of the server; and
causing, based on the health state, determination of whether to replace the server.

11. The system of claim 10, the computer-executable instructions that when further executed by the processor cause the system to execute a method comprising:
training, based at least in part on the pair of embeddings, the Siamese network.

12. The system of claim 10, wherein the Siamese network includes a plurality of neural networks in parallel, wherein one of the plurality of neural networks receives first embeddings representing reference data as input, and wherein another one of the plurality of neural networks receives second embeddings representing incident data as input.

13. The system of claim 10, wherein the Siamese network includes a first neural network and a second neural network, and wherein a first layer of the first neural network and a first layer of the second neural network are trained by sharing common weight values.

14. The system of claim 10, wherein the determining the hardware failure rate is based on fitting an exponential distribution of hardware failures associated with a set of hardware resources with hardware failures associated with the server.

15. The system of claim 10, wherein the determining a performance rate includes determining a residual of a linear regression model between hourly machine performance data and a number of client requests received on the server.

16. The system of claim 10, wherein the determining a power consumption degradation further includes determining a residual of a linear regression model indicating an increase of power consumption as a processor utilization increases and a power consumption by the server when the server is in an idle state.

17. A computer-implemented method, comprising:
retrieving data associated with feature variables, wherein the feature variables indicate a health state of a hardware resource, wherein the feature variables include performance data associated with the hardware resource;
determining degradation of values associated with the feature variables using a linear regression model;
training a Siamese network using embeddings representing a healthy state as training data; and
determining, based on a plurality of embeddings associated with the feature variables, the health state using the trained Siamese network.

18. The computer-implemented method of claim 17, wherein the Siamese network includes a plurality of neural networks in parallel, wherein one of the plurality of neural networks receives first embeddings representing reference data as input, and wherein another one of the plurality of neural networks receives second embeddings representing incident data as input.

19. The computer-implemented method of claim 17, wherein the Siamese network includes a first neural network and a second neural network, and wherein a first layer of the first neural network and a first layer of the second neural network are trained by sharing common weight values.

20. The computer-implemented method of claim 17, wherein the determining degradation of values associated with the feature variables includes determining a residual of a linear regression model between hourly machine performance data and a number of client requests received on the hardware resource.
